(19) United States
(12) Patent Application Publication
(10) Pub. No.: US 2004/0084975 A1
(43) Pub. Date: May 6, 2004

(54) Gas-cooled generator stator

(76) Inventor: Denis Thiot, Belfort (FR)

Correspondence Address: ADAM J. CERMAK, LAW OFFICE OF ADAM J. CERMAK, P.O. BOX 7518, ALEXANDRIA, VA, 22307-7518, US

(21) Appl. No.: 10/667,326

(22) Filed: Sep. 23, 2003

(30) Foreign Application Priority Data
Sep. 23, 2002 (GB) 0222054.9

(51) Int. Cl. H02K 9/00

(52) U.S. Cl. 310/58

(57) ABSTRACT

In a generator with indirect cooling, the stator has a core 12 comprising mutually spaced packets of core laminations, radial ducts 11 being defined between the packets for the passage of gaseous coolant between the inner and outer peripheries of the core. The core 12 has axial slots 18 which accommodate armature bars 16, 17. The stator incorporates baffles 19 arranged in such a manner that gaseous coolant flowing radially in a radial duct 11a from one periphery of the core enters a slot 18 adjacent the duct 11a and flows in a direction along the slot 18 before entering one of the radial ducts, in which it flows radially toward the other periphery of the core. Accordingly, heat from the bars 16, 17 primarily passes directly into the flowing gaseous coolant. The radial flow may be either inwards (as shown) or outwards.

### BACKGROUND OF THE INVENTION

1. Field of the Invention

This invention relates to a stator for a generator.

2. Brief Description of the Related Art

Generators are typically cooled by circulating a gaseous coolant through ducts in the rotor and stator. FIG. 1 of the accompanying drawings shows an axial cross-section through a conventional generator with reverse flow ventilation of the stator. In the generator shown in FIG. 1, a rotor 1 rotates about an axis 2 inside a generally cylindrical stator 3. Air, or another gaseous coolant, is drawn from the annular gap 4 between the rotor and the stator by a fan 6 on each end of the rotor and is directed to a cooler 7 at each end of the stator. As indicated by the arrows 8, the cooled air is distributed to the outer periphery 9 of the stator 3 and passes radially inwardly through ducts 11 in the core 12 of the stator before emerging through the inner periphery 13 into the gap 4.

Although reverse flow ventilation is the preferred ventilation mode for large generators with indirect cooling, centrifugal flow ventilation is generally suitable for generators, in which case the coolant flows radially outwardly through the ducts 11 in the core 12 (the directions of the arrows in FIG. 1 being reversed).

The ducts 11 are defined between mutually spaced packets 14 of core laminations. Armature bars 16, 17 are accommodated in axial slots 18 in the core 12; each bar comprises a copper conductor surrounded by a layer of insulation. The gaseous coolant does not directly contact the copper conductor. Heat generated in the conductor is thermally conducted through the layer of insulation to the side walls of the slot 18, from where the heat is conducted through the lamination packets 14 to the cooling ducts 11.

It would be desirable to be able to improve the heat transfer from the bars to the gaseous coolant.

### SUMMARY OF THE INVENTION

The present invention provides a stator for a generator with indirect cooling, the stator having a core comprising mutually spaced packets of core laminations, radial ducts being defined between the packets for the passage of gaseous coolant between the inner and outer peripheries of the core, the core having axial slots which accommodate armature bars, the stator incorporating baffles arranged in the radial ducts in such a manner that they cause gaseous coolant flowing radially in one of the radial ducts from one periphery of the core to enter a slot adjacent the said duct and flow in a direction along the slot before entering one of the radial ducts, in which it flows radially toward the other periphery of the core.

Preferred and optional features of the invention are set forth in the dependent claims.

### BRIEF DESCRIPTION OF THE DRAWINGS

The invention will be described further, by way of example only, with reference to the accompanying drawings, in which:

FIG. 1 is a schematic partial axial cross-section through a generator;

FIG. 2 is a diagrammatic partial transverse cross-section through a stator according to a first embodiment of the invention;

FIG. 3 is a diagrammatic partial circumferential cross-section taken on line III-III in FIG. 2;

FIG. 4 is a diagrammatic transverse cross-section through a stator slot, showing one way of spacing the armature bars from the slot walls;

FIG. 5 is a view similar to FIG. 4, showing another way of spacing the armature bars from the slot walls;

FIG. 6 is a diagrammatic partial axial cross-section through a modified stator with wedging packets;

FIG. 7 is a circumferential cross-section taken on line VII-VII in FIG. 6;

FIG. 8 is a view similar to FIG. 7, showing a preferred feature of the first embodiment;

FIG. 9 is a diagrammatic partial axial cross-section through a second embodiment of the stator; and

FIG. 10 is a diagrammatic partial axial cross-section through a third embodiment of the stator.

### DESCRIPTION OF THE PREFERRED EMBODIMENTS

Throughout the drawings, similar features are indicated by the same reference numerals.

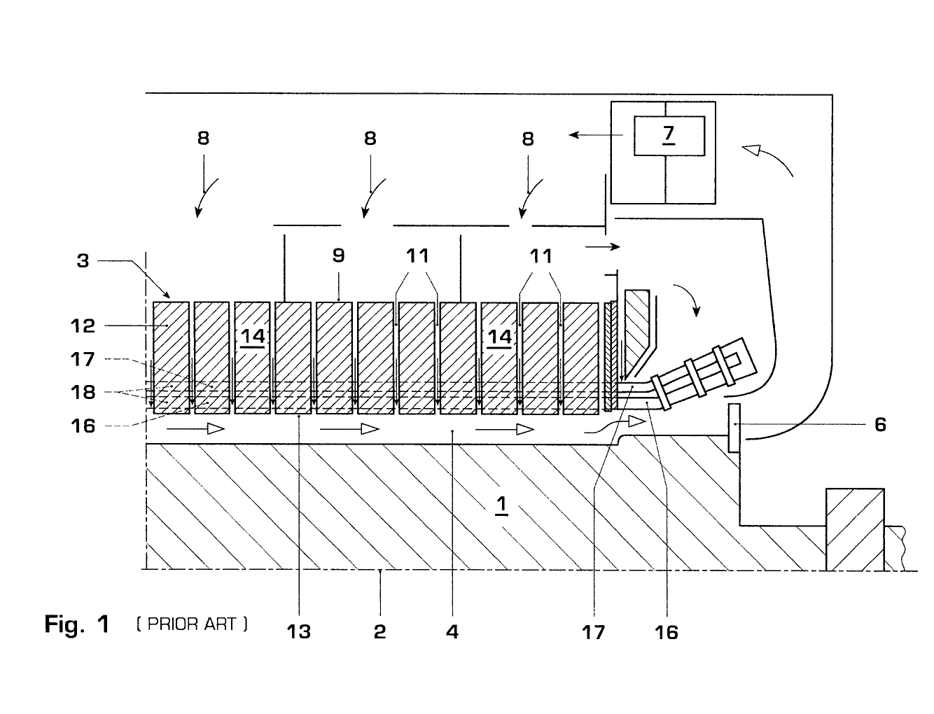

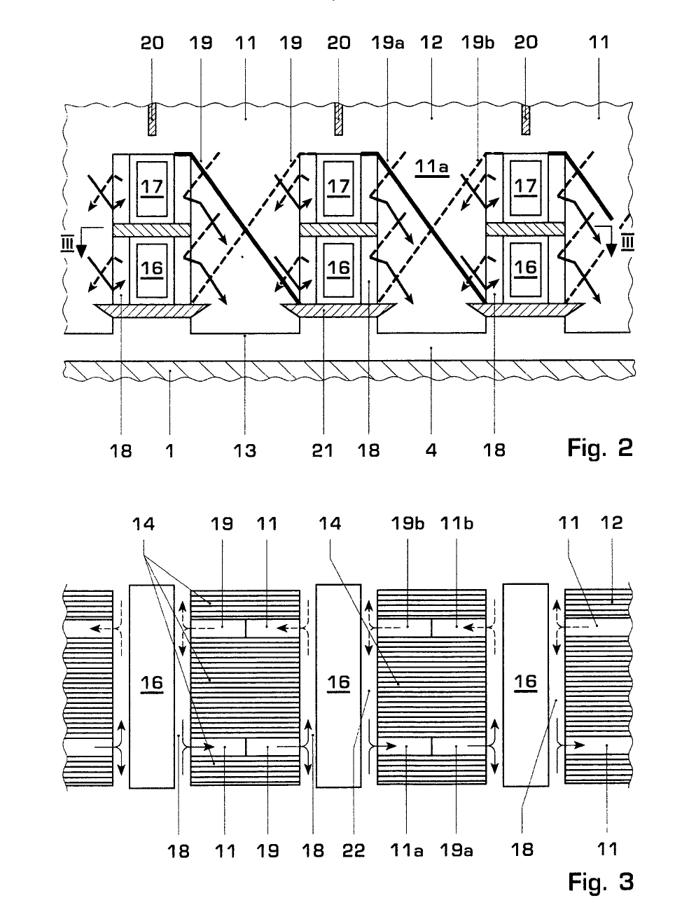

The stator described below with reference to FIGS. 2 to 10 forms part of a generator which has an output of about 300 MVA or more and which is basically similar to the type of generator described above with reference to FIG. 1.

The embodiment of stator shown in FIGS. 2 and 3 has oblique baffles 19 arranged in the ducts 11, between the slots 18. Consider two ducts 11a and 11b (FIG. 3) which are separated from each other by a single packet 14 of core laminations. The first duct 11a contains a first baffle 19a which is angled with respect to the radial and circumferential directions of the stator and which extends from the base of one slot 18 to a closure constituted by a stator wedge 21 in the open end portion of the next slot 18. The baffle 19a blocks the duct 11a so that the gaseous coolant flowing radially inwardly in the duct 11a is deflected or diverted into one side of the adjacent slot 18 and flows in the available void space 22 between the bar 16 and the adjacent wall of the slot. It will be noted that, on entering the slot 18, the flow of gaseous coolant diverges in opposite directions along the slot. From the duct 11a, the gaseous coolant passes through the lamination packet 14 (in a direction along the slot) before entering the second duct 11b at a location downstream of the baffle 19b in that duct. The second baffle 19b is angled in the opposite sense to the first baffle 11a and deflects the gaseous coolant leaving the side of the slot 18 so that it flows radially inwardly and leaves the duct 11b at the inner periphery 13 of the core 12.

Accordingly, if each bar 16 (or 17) is considered in the axial direction, the successive ducts 11 that it meets direct the coolant gas alternately to the right and left sides of the bar. The heat generated in the copper conductors of the bars 16, 17 primarily passes directly into the flowing gaseous coolant after passing through the layer of insulation.

The bars 16, 17 have to have some sort of lateral wedging to provide a sufficient gap (for example from about 1 mm to about 2 mm) to allow the coolant gas to flow along the slots 18. The lateral wedging also resists oscillating forces in the circumferential direction.

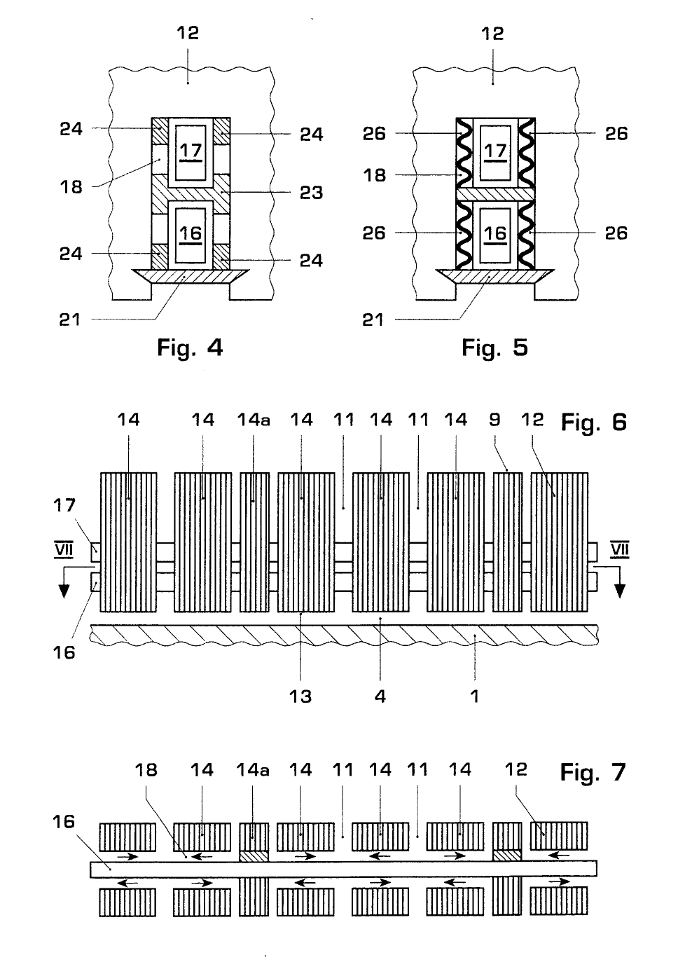

FIG. 4 shows spacers constituted, on the one hand, by a filler 23 between the bars 16 and 17 and, on the other hand, by lateral wedges 24 occupying only part of the radial height of each bar. FIG. 5 shows an alternative spacing arrangement, with lateral wedging springs 26 which have either corrugations extending along the slot 18 or protuberances making only local contact with the core 12 and the bars 16, 17. FIGS. 6 and 7 shows a further alternative arrangement, in which between two of the normal lamination packets 14 there is a wedging packet 14a in which the laminations extend into the width of each slot 18 and make contact with the armature bars 16, 17. The wedging packet 14a is thinner than the non-wedging packet 14. Furthermore, the space between a wedging packet 14a and a non-wedging packet 14 is less than that between adjacent non-wedging packets 14. In effect, the wedging packet 14a divides a normal coolant duct into two narrower ducts.

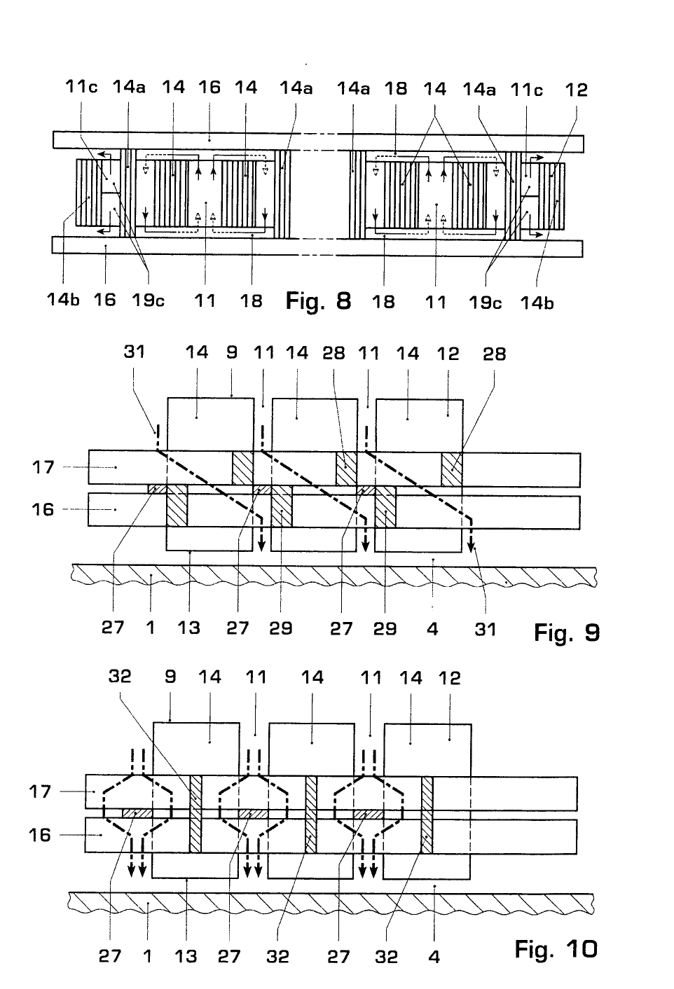

FIG. 8 shows a presently preferred arrangement in which there are two (or more) non-wedging packets 14 from about 70 to about 100 mm thick between each pair of wedging packets 14a about 50 mm thick or less. The ducts 11 between the non-wedging packets are about 10 mm thick and the ducts between each non-wedging packet 14 and the adjacent wedging packet 14a are each about 5 mm thick. For a generator with an output of about 300 MVA, the total length of the stator may be about 4000 mm or more. At each end of the stator core 12 symmetrical baffles 19c are arranged in the radial ducts 11c between an end packet 14b and an adjacent wedging packet 14a so that the gaseous coolant flowing radially inwardly in the ducts 11c enters both of the slots 18 adjacent each duct 19c and flows along the slots 18 to the end of the core 12.

As is known, the surfaces of the bars 16, 17 may be coated with a conductive paint or tape, which is earthed at a sufficient number of points along the bar in order to prevent electrical discharges occurring in the void spaces and to limit the power dissipated in the contacts. Typically, for the usual values of paint or tape resistance, contact resistances, operating voltage, capacitance, and voltage induced along the bars, the maximum spacing between earthing contacts has to be of the order of 200 mm.

The baffles 19 may be made of sheet metal and serve as spacers between the lamination packets 14 in addition to other spacing means such as conventional sheet metal spacers 20 (FIG. 2) for delimiting the radial ducts 11.

FIG. 9 shows a possible second embodiment of the stator. Each duct 11 contains a baffle 27, which extends in the axial and circumferential directions, at a location between the two armature bars 16, 17. One axial end of the baffle 27 extends to a gap closure 28 between the radially outer bar 17 and the walls of the slot 18, and the other end of the baffle 27 extends to a gap closure 29 between the radially inner bar 16 and the walls of the slot. Thus the space between the bars in the ducts is closed off over the entire circumference of the stator core 12. The gaseous coolant passes diagonally through each lamination packet 14 from one cooling duct 11 to the next, as indicated by the arrows 31 in FIG. 8.

The third embodiment shown in FIG. 10 differs from the embodiment shown in FIG. 9 in that the gap closures 28 and 29 are omitted. Accordingly each baffle 27 acts as a chicane causing the gaseous coolant flowing radially inwardly in a duct 11 to enter each of the slots adjacent the duct and to flow first away from the duct (into the adjacent lamination packets 14) before flowing back along the slot into the same duct 11. As shown in FIG. 10, the slot is blocked by partitions 32 at the mid-thickness of the lamination packets 14.

Various modifications may be made within the scope of the invention. For example, features of any one of the embodiments described above may be combined with features of one or more of the other embodiments, in the same stator. Furthermore, although indirect cooling with reverse flow has been described, the embodiments may instead be used for indirect cooling with centrifugal flow, in which the arrows shown in FIGS. 2, 3, and 8 to 10 are reversed.

What is claimed is:

1. A stator for a generator with indirect cooling, the stator comprising:
a core including mutually spaced packets of core laminations, radial ducts being defined between the packets for the passage of gaseous coolant between the inner and outer peripheries of the core, the core having axial slots configured and arranged to accommodate armature bars;
baffles arranged in the radial ducts configured and arranged to cause gaseous coolant flowing radially in one of the radial ducts from one periphery of the core to enter a slot adjacent said duct and flow in a direction along said adjacent slot before entering one of the radial ducts, in which said one of the radial ducts the gaseous coolant can flow radially toward the other periphery of the core.

2. A stator as claimed in claim 1, further comprising:
a plurality of armature bars positioned in said axial slots.

3. A stator as claimed in claim 2, further comprising:
lateral spacers in said slot defining passages for the gaseous coolant between the core and armature bars.

4. A stator as claimed in claim 3, wherein the lateral spacers comprise lateral wedging elements occupying only part of the radial height of an armature bar.

5. A stator as claimed in claim 3, wherein the lateral spacers comprise lateral wedging springs having corrugations extending along the slot or protuberances making only local contact with the core and with the armature bars.

6. A stator as claimed in claim 5, comprising a series of at least two non-wedging packets between two wedging packets.

7. A stator as claimed in claim 6, wherein the spacing between the non-wedging packets is greater than the spacing between each wedging packet and an adjacent non-wedging packet.

8. A stator as claimed in claim 2, wherein at least one of the packets of core laminations comprises a wedging packet in which the laminations extend into the width of each slot and make contact with the armature bars.

9. A stator as claimed in claim 8, wherein the wedging packet is thinner than the non-wedging packets.

10. A stator as claimed in claim 1, wherein the axial slots and radial ducts are configured and arranged so that gaseous coolant flowing radially in a first one of the radial ducts from said one periphery of the core enters a slot adjacent the first duct and flows in a direction along said slot before entering a second one of the radial ducts, in which second one of the radial ducts the gaseous coolant flows radially toward the other periphery of the core.

11. A stator as claimed in claim 10, wherein the first and second ducts are separated from each other by a single packet of core laminations.

12. A stator as claimed in claim 11, wherein said baffles comprise first and second oblique baffles; and
wherein the first duct contains the first oblique baffle which is angled with respect to the radial and circumferential directions of the stator and which deflects the gaseous coolant into one side of said slot, and wherein the second duct contains the second oblique baffle which is angled in the opposite sense to the first oblique baffle and which deflects the gaseous coolant leaving said one side of the slot so that the gaseous coolant flows radially.

13. A stator as claimed in claim 12, wherein said slot comprises an open end portion, and further comprising:
a closure in the open end portion of said slot; and
wherein one of the first and second oblique baffles extends to said closure.

14. A stator as claimed in claim 12, wherein one of the first and second baffles extends from the base of the said slot.

15. A stator as claimed in claim 12, wherein the first and second baffles substantially block the first and second ducts.

16. A stator as claimed in claim 10, comprising two second ducts, one of said two second ducts positioned on each side of the first duct.

17. A stator as claimed in claim 10, further comprising:
a plurality of gap closures; and
wherein each of the first and second ducts contains a baffle at a location between two armature bars arranged one on top of the other in said slot, one axial end of each baffle extending to a gap closure between one of the two armature bars and the walls of the slot, and the other end of each baffle extending to a gap closure between the other of the two armature bars and the walls of the slot.

18. A stator as claimed in claim 1, wherein the axial slots and radial ducts are configured and arranged so that gaseous coolant flowing radially in one of the radial ducts from said one periphery of the core enters a slot adjacent said one duct and flows first in one direction along the slot and then in an opposite direction along the slot before re-entering said one duct.

19. A stator as claimed in claim 18, further comprising:
a baffle in said one duct which baffle deflects the gaseous coolant into one side of said slot.

20. A stator as claimed in claim 19, wherein said baffle substantially blocks said duct so that substantially all of the gaseous coolant flowing through said duct passes through the slot portions on both sides of the said duct.

21. A stator as claimed in claim 1, wherein the axial slots and the radial ducts are configured and arranged so that at one end of the core the gaseous coolant flowing radially in one of the radial ducts from said one periphery of the core enters both of the slots adjacent said duct and flows along the slots to the end of the core.
